(19) United States
(12) Patent Application Publication
(10) Pub. No.: US 2010/0142104 A1
(43) Pub. Date: Jun. 10, 2010

(54) SYSTEM AND METHOD FOR ELECTRICAL PROTECTION OF APPLIANCES

(76) Inventors: Anthony A. COOPER, Crestwood, KY (US); Mark Fredrick Culler, Prospect, KY (US); Scott H. Welham, Prospect, KY (US); Richard DeVos, Goshen, KY (US); William T. Moon, Taylorsvile, KY (US); Telema Harry, Louisville, KY (US)

Correspondence Address: General Electric Company;GE Global Patent Operation, 2 Corporate Drive, Suite 648, Shelton, CT, 06484, US

(21) Appl. No.: 12/329,687

(22) Filed: Dec. 8, 2008

(51) Int. Cl. H02H 9/00

(52) U.S. Cl. 361/49

(57) ABSTRACT

An electrical protection system includes a household electronic device and an electrical protection unit permanently interfaced therewith. The household electronic device is configured for detachable electric connection to an external household source and to utilize electrical power received from the household source. The electronic device operates according to an electrical power waveform, e.g., the device exhibits the electrical power waveform during operation. The electrical protection unit is configured to allow electrical power to pass from the household source to the electronic device if the power waveform is within a waveform profile, and to prevent electrical power from passing from the household source to the electronic device if the power waveform is outside a fault deviation of the waveform profile. The waveform profile is indicative of normal electrical operation of the electronic device, across its entire operational range.

### FIELD OF THE INVENTION

The subject matter of the present invention relates to electronic systems and devices and, more particularly, to electrical protection circuits for electronic systems and devices.

### BACKGROUND OF THE INVENTION

Many household electrical or electronic devices are configured to utilize a standard wall outlet voltage waveform as an input power source, e.g., 110-120 volts AC at 60 Hz in the United States. Oftentimes, the AC input voltage is stepped down to a lower DC voltage using a transformer-based power supply internal to the device. In an electronic device, e.g., a household electric appliance, if a high voltage power wire or other voltage source internal to the electric appliance happens to electrically contact an external conductive surface of the device such as a metal housing (due to damage of the device or otherwise), the possibility exists for a person to be electrically shocked if he or she shorts the “live” conductive surface to ground. The same is true if a person accesses the electronic device internally and contacts a high voltage power wire or other voltage source inside the device.

Electrical protection devices exist for preventing shock hazards of the type noted above in household electronic devices. However, for determining when a fault condition exists, typical electrical protection devices are configured to monitor the power waveform of a device circuit (e.g., current flow) in a generic sense, based on relatively low levels of power waveform fluctuation. That is, fault conditions are determined based on the smallest degree of waveform fluctuation that might in theory present an electrical hazard, regardless of the type or characteristics of the electronic device in question. This “one size fits all” approach may result in the electrical protection device errantly activating, without the occurrence of a hazardous electrical fault, thereby unnecessarily disrupting operation of the household electronic device in question.

### BRIEF DESCRIPTION OF THE INVENTION

An embodiment of the present invention relates to an electrical protection system comprising a household electronic device and an electrical protection unit permanently interfaced with the household electronic device. (By “permanently interfaced,” it is meant that the electrical protection unit cannot be removed from the household electronic device without disabling the household electronic device.) The household electronic device is configured for detachable electric connection to an external household source (e.g., a wall outlet) and to utilize electrical power received from the household source. The electronic device operates according to an electrical power waveform, by which it is meant that the electronic device exhibits the electrical power waveform during operation. The electrical power waveform may include one or more electrical measurements (e.g., voltage and/or current over time) at one or more points of the electronic device.

The electrical protection unit is configured to allow electrical power to pass from the household source to the electronic device (or a portion thereof) if the power waveform is within a waveform profile, and to prevent electrical power from passing from the household source to the electronic device if the power waveform is outside a fault deviation of the waveform profile. The waveform profile is indicative of normal electrical operation of the electronic device, e.g., it is an electric “signature” of the electronic device during operation under designated normal conditions, across its various modes of operation. The fault deviation indicates the amount or extent to which the measured electrical power waveform of the electronic device can vary or deviate from the waveform profile before the electronic device is considered to be in a fault condition and not operating normally.

Thus, in operation, in one embodiment, the electrical protection unit allows electrical power to pass to the electronic device across the entirety of the electronic device's normal electrical operational range, as defined by the waveform profile. However, if the electronic device begins to operate outside its normal electrical operational range, which might be indicative of a short circuit or other electrical fault condition, the electrical protection unit prevents electrical power from passing to the electronic device. The fault deviation accommodates excursions outside the normal electrical operational range of the device that are not considered significant enough to be indicative of a fault condition.

In one embodiment, the electrical protection unit includes an AFCI (arc fault circuit interrupter) unit, a GFCI (ground fault circuit interrupter) unit, or a combination GFCI/AFCI unit.

Another embodiment of the present invention relates to a method for electrically protecting a household electronic device. An electrical waveform profile of the household electronic device is generated when the household electronic device is operating under designated normal conditions. An electrical protection unit is selected based on the waveform profile. The electrical protection unit is selected to allow electrical power to pass to the household electronic device from an external household source if an operational electric power waveform of the household electronic device falls within the waveform profile. Additionally, the electrical protection unit is selected to substantially prevent electrical power from passing to the household electronic device from the external household source if the operational electric power waveform of the household electronic device falls outside a fault deviation of the waveform profile. Once the electrical protection unit is selected, it is permanently integrated with the household electronic device, prior to distribution of the household electronic device to a household end user. This prevents the electrical protection unit from being removed from the household electronic device without disabling the electronic device.

This brief description of the invention is provided to introduce a selection of concepts in a simplified form that are further described herein. This brief description of the invention is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure. Also, the inventors herein have recognized any identified issues and corresponding solutions.

### DESCRIPTION OF THE FIGURES

The present invention will be better understood from reading the following description of non-limiting embodiments, with reference to the attached drawings, wherein below:

FIGS. 1-3 and 5-8 are schematic views of an electrical protection system according to various embodiment of the present invention;

FIG. 4 is a schematic view of an illustrative waveform; and

FIG. 9 is a flowchart illustrating a method for electrically protecting a household electronic device, according to another embodiment of the present invention.

### DETAILED DESCRIPTION

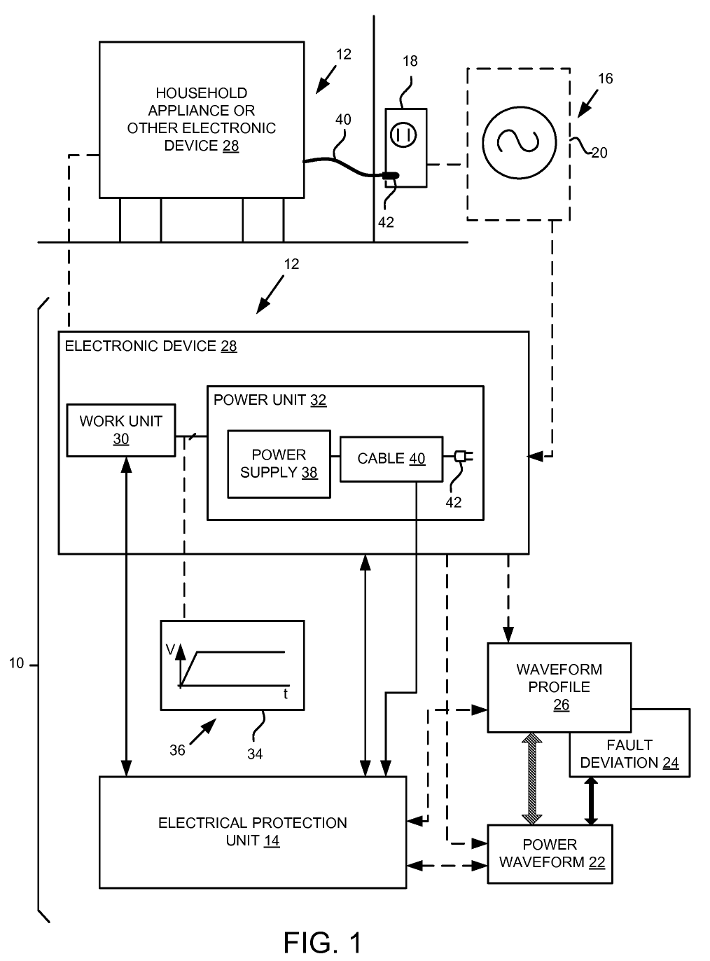

Turning first to FIG. 1, an embodiment of the present invention relates to an electrical protection system 10 comprising a household electronic device 12 and an electrical protection unit 14 permanently interfaced with the household electronic device 12. The household electronic device 12 is configured for detachable electric connection to an external household source 16 (e.g., a wall outlet 18) and to utilize electrical power 20 received from the household source 16. The electronic device 12 operates according to an electrical power waveform 22, by which it is meant that the electronic device 12 exhibits the electrical power waveform 22 during ongoing operation. The electrical power waveform 22 may include one or more electrical measurements, e.g., voltage and/or current over time, taken at one or more electrical/circuit points of the electronic device.

The electrical protection unit 14 is configured to allow electrical power 20 to pass from the household source 16 to the electronic device 12 (or a portion thereof) if the power waveform 22 is within a waveform profile 26, and to prevent electrical power 20 from passing from the household source 16 to the electronic device 12 if the power waveform 22 is outside a fault deviation 24 of the waveform profile 26. The waveform profile 26 is indicative of normal electrical operation of the electronic device 12, e.g., it is an electric “signature” of the electronic device during operation under designated normal conditions. The fault deviation 24 is an amount or extent to which the electrical power waveform 22 of the electronic device 12 can vary or deviate from the waveform profile 26 before the electronic device is considered not to be operating normally and thereby to be in a fault mode.

Thus, in operation, in one embodiment, the electrical protection unit 14 allows electrical power 20 to pass to the electronic device 12 across the entirety of the electronic device's normal electrical operational range, as defined by the waveform profile 26. However, if the electronic device 12 begins to operate outside its normal electrical operational range, which might be indicative of a short circuit condition, an undesired electrical arcing condition, or other electrical fault, the electrical protection unit 14 prevents electrical power from passing to the electronic device. The fault deviation 24 accommodates excursions outside the normal electrical operational range that are not considered significant enough to be indicative of a fault condition.

Operational considerations of fault deviation 24 can be on an express basis or an implied basis. In the former, the power waveform 22 is measured on an ongoing basis, and a calculation or other determination is made of whether the power waveform 22 is within the fault deviation 24 of the waveform profile 22. In the latter, the electrical protection unit 14 is configured so that its electrical fault criteria or conditions for preventing power from passing to the electronic device are outside the normal operational range of the electronic device. In other words, the electrical protection unit is configured so that its criteria for cutting off power to the device are never met when the electronic device is operating normally in any of its various modes of operation.

The electronic device 12 is a standard household electronic device (e.g., a device powered by electricity), such as a stand-alone household appliance. In a typical configuration, the electronic device 12 includes a housing 28, a work unit 30 at least partially housed inside the housing 28, and a power unit 32, part of which is also housed inside the housing 28, electrically connected to the work unit 30. As an example, the housing 28 may be formed of one or more polymer and/or metal sheets and other components connected together to define an interior space and an exterior surface of the electronic device 12.

The electrical power unit 32 is configured for detachable electric connection to the household source 16, which is external to the electronic device 12, for receiving electrical power 20 from the external source. (This does not preclude the electronic device from having one or more internal batteries or other internal electrical power sources, but in at least one mode of operation the electronic device 12 draws power from the external source 16.) The electrical power unit 32 is configured to receive and utilize the external electrical power 20 received from the household source, which includes simply channeling the electrical power 20 to the work unit 30, converting the electrical power 20 into a waveform 34 adapted for use by the work unit 30 (including power regulation and/or voltage transformation), or the like. (For the sake of explanation, electrical power supplied by the electrical power unit 32 is referred to herein as internal electrical power 36, regardless of whether the electrical power unit 32 converts or otherwise modifies the received external electrical power 20.) In one embodiment, for example, the electrical power unit 32 includes a power supply 38, an electrical cable 40 electrically connected to the power supply 38, and an electrical plug 42 electrically terminating the cable 40. The plug 42 is a standard electrical plug (e.g., a NEMA 5 3-prong male plug) that is dimensioned to be removably received in the household source 16 (e.g., a female wall outlet 18 electrically connected to a household electric circuit) for establishing a detachable electrical connection between the household source 16 and electrical cable 40 (and thereby an electrical connection between the household source 16 and the power supply 38). As noted above, the power supply 38 may include circuitry for regulating and/or converting the external electrical power 20 received over the plug 42 and cable 40 from the external source 16. For example, in some electronic devices the power supply 38 converts the received external electrical power 20 to one or more DC voltages 34 for supply to various circuit components of the electronic device.

In a typical case, the electrical power 20 that is output by the household source 16 will be a standard power waveform for the geo-political area in which the household source 16 is located. For example, the standard power waveform in the United States is either 110-120 volts AC at 60 Hz (for standard or light-duty circuits) or 240 volts AC at 60 Hz for heavy-duty applications, e.g., clothes dryers and electric cooking ranges. In many other countries, the standard power waveform available at a household source 16 is 220-240 volts AC at 50 Hz. Thus, electronic devices 12 will typically be configured to utilize electrical power at about 110-240 volts AC at 50-60 Hz as received from the household source 16. (“About” means that the electronic device will work within this range, or a subset of this range, and that the electronic device will also work if the external electrical power fluctuates, due to supply variations from the power grid, up to ±5%.)

The work unit 30 is electrically connected to the power unit 32. The work unit 30 is electrically configured to use the internal electrical power 36 received from the power unit 32 (i.e., the work unit 30 runs on the internal electrical power 36) for carrying out one or more designated work functions of the electronic device. “Work function” refers to an electrically powered function or operation that the electronic device carries out at a macro, end-user application level (i.e., a function that the electronic device is used for by an end user). Examples include heating a stove element, turning a drum and heating air inside an electric clothes dryer, and the like.

The electrical protection unit 14 is permanently interfaced with the electronic device 12, by which it is meant that the electrical protection unit 14 cannot be removed from the electronic device without disabling the household electronic device. More specifically, the electrical protection unit 14 cannot be removed from the electronic device by an end user (e.g., a consumer) without putting the electronic device into a state that would require electrical repair for the electronic device to be functional. This prevents an end user from casually bypassing or disabling the functionality of the electrical protection unit 14, as might result in an unsafe condition.

The electrical protection unit 14 automatically controls the passage of electrical power from the external source 16 to the electronic device 12 in an “on/off” manner, for cutting off power to the electronic device if it enters a fault condition (e.g., an electrical short that might harm an end user), but while also accommodating the entire normal operational range of the electronic device 12. Thus, the electrical protection unit 14 automatically determines (e.g., as a function/result of its circuit/electric topology) whether the electronic device is operating normally, as expected. If so, the electrical protection unit 14 does nothing, and allows electrical power to pass to the electronic device 12. On the other hand, if the electrical protection unit 14 determines that the electronic device is not operating normally, the electrical protection unit 14 automatically prevents electrical power from passing from the external source 16 to the electronic device 12. For example, if normal operation of the electronic device includes current spikes at regular intervals and an associated transient mismatch of current levels in the power input/output lines of the cable 40 (or internal electrical lines of the electronic device connected thereto), due to device startup or cycling, battery charging, or the like, the electrical protection unit 14 does nothing. However, if in addition to the regular current spikes there is an unexpected current mismatch or imbalance in the power input/output lines, of the type that might indicate that electrical current is being shunted to ground in a non-intended manner, the electrical protection unit 14 automatically cuts off power to the electronic device. This is done quickly enough (e.g., <50 msec) to prevent substantial human injury due to electrical shock.

As should be appreciated, when the electrical protection unit is characterized herein as cutting off power to the electronic device, or preventing electrical power from passing from the external source to the electronic device, this includes both (i) electrical power is completely cut off (i.e., current draw=0 amperes) or (ii) electrical power/current is substantially prevented from passing to the electronic device, as further explained below with reference to FIG. 5, by way of example.

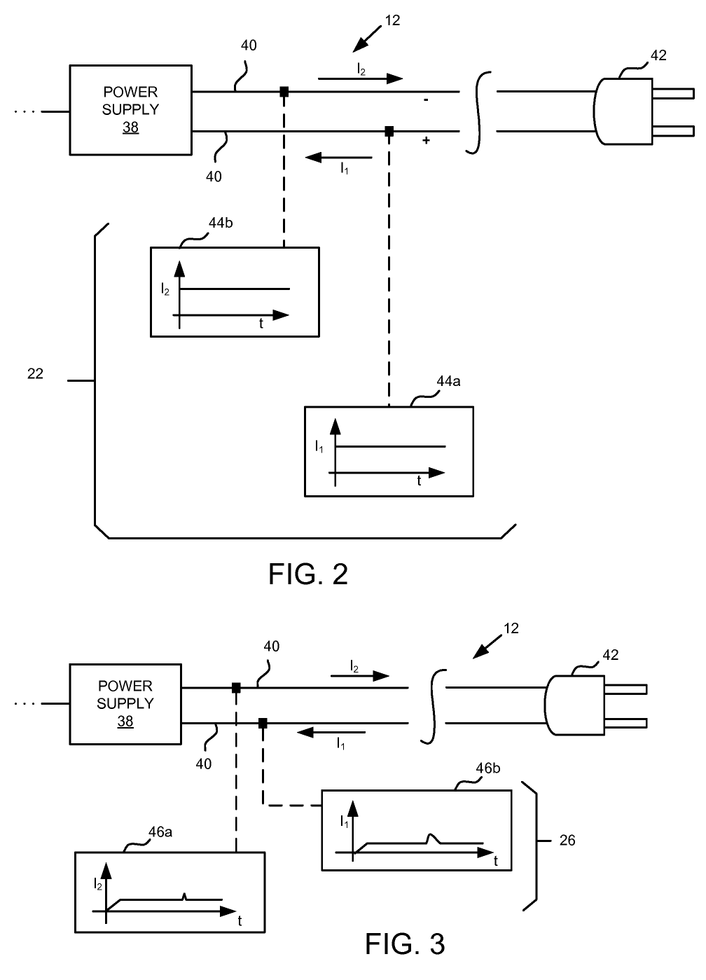

In one embodiment, selection and operation of the electrical protection unit 14 is based on several factors. These include the electronic device waveform profile 26, the electronic power waveform 22, and the fault deviation 24. The power waveform 22 is an electrical measure of the electronic device in ongoing operation, e.g., in “everyday” use in the home of an end user. The power waveform 22 may include voltage measurements over time at one or more circuit points in the electronic device, current measurements over time at one or more circuit points in the electronic device, a composite of the two (e.g., electrical power measurements), or the like. Thus, the power waveform 22 is in effect a composite of one or more electrical measurements of the electronic device 12 in ongoing operation. An example power waveform 22 is shown in FIG. 2. As indicated, the power waveform 22 includes two current measurements 44a, 44b at two different points in the electronic device 12. The first current measurement 44a is taken at the positive supply line of the cable 40, and the second current measurement 44b is taken at the ground or neutral supply line of the cable 40. Of course, instead of electrical current measurements, there could be voltage measurements at these points, or voltage and/or current measurements taken at different circuit points in the electronic device.

Typically, power waveform measurements are taken on an ongoing basis, e.g., current or voltage is measured as a function of time. Measurements over time may be taken continuously, in an analog manner, or may be taken periodically, based on digital sampling or a similar technique. (Samples would typically have to be taken fairly regularly, e.g., 1000 Hz, for quick response to a fault condition.)

The electronic device waveform profile 26 is indicative of normal electrical operation of the electronic device 12, e.g., as noted above, the waveform profile 26 can be thought of as an electric “signature” of the electronic device during operation under designated normal conditions. The designated normal conditions typically include (i) the electronic device operating as designed and intended, without any electrical faults such as faulty components, circuit shorts, or circuit opens, and (ii) the electronic device receiving a designated input power waveform. Other factors, or different factors, may be considered depending on the nature of the device, e.g., environmental conditions.

In one embodiment, to obtain the waveform profile 26, the electronic device 12 is tested prior to distribution to a consumer or other household end user. First, the electronic device 12 is inspected to make sure it is order, including that the component parts of the electronic device are operational and functioning and that there are no errant short or open circuit conditions in the electronic device. Then, the electronic device 12 is connected to an external power source that is regulated to ensure that it is outputting a power waveform that the electronic device is designed to receive and use as input power. (For example, if the electronic device is designed to accept a 120V AC 60 Hz input power signal, then the external power source is regulated to ensure it is outputting a 120V AC 60 Hz power signal.) Subsequently, the electronic device 12 is operated in its various modes of operation, to ensure that the electronic device is operating as designed and intended. Once the electronic device 12 is verified as functioning as intended, one or more designated electrical measurements are taken of the electronic device 12 in operation over time, across one or more modes of operation. (Typically, the electrical measurements are taken across all the various modes of operation of the electronic device.) These measurements constitute the waveform profile 26 of the electronic device 12. The points of measurement of the waveform profile 26 (and what is measured at these points) correspond to the points of measurement of the power waveform 22 that will be monitored in ongoing operation of the electronic device. That is, since the electrical protection unit 14 is configured to monitor the device's power waveform 22 while accommodating the various operational modes of the electronic device 12, the operational modes are electrically characterized in the waveform profile 26 in correspondence with what the electrical protection unit 14 measures in ongoing operation.

As an example, with reference to FIG. 3, if the power waveform 22 of an electronic device 12 (i.e., the power waveform that will be monitored in ongoing operation) constitutes two current measurements 44a, 44b as shown in FIG. 2, then the waveform profile 26 will typically constitute two current measurements 46a, 46b at the same circuit points, which are taken while the device is operating under designated normal conditions, across its various modes of operation.

As should be appreciated, many electronic devices are electrically specified (namely, their electrical characteristics are recorded in a set of specifications) during development and rollout. Accordingly, it may be possible to derive all or part of the waveform profile 26 from the specifications of the electronic device in question, for example, voltage and maximum current of the appliance or other electronic device.

In operation, the electrical protection unit 14 monitors the power waveform 22 of the electronic device. More specifically, the electrical protection unit 14 measures one or more designated electrical characteristics of the electronic device during ongoing operation of the device, at one or more designated points of the electronic device, where the measurements in combination form the power waveform 22. If the power waveform 22 is within the waveform profile 26 of the device (e.g., if the power waveform matches the waveform profile), then the electrical protection unit 14 continues to monitor the power waveform 22 but does nothing further. If the power waveform 22 is outside the waveform profile 26 (e.g., if the power waveform deviates from the waveform profile), this is indicative of a possible fault condition. However, since the power waveform 22 may vary from the waveform profile 26 even in normal operation, e.g., slight variations, the fault deviation 24 is taken into consideration to ensure that that the electrical protection unit 14 does not unnecessarily cut off power to the electronic device. The fault deviation 24 is an extent that the power waveform 22 must vary from the waveform profile 26 (typically as a function of both measured electrical values and time) before the electrical protection unit 14 prevents power from passing from the household source 16 to the electronic device.

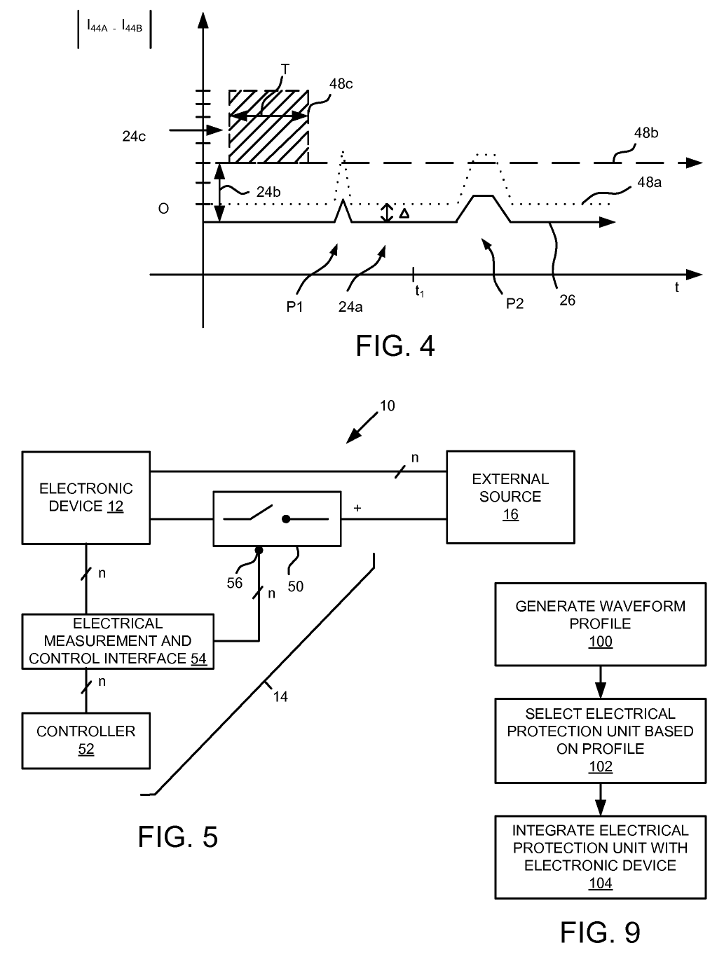

Hypothetical example power waveforms, waveform profiles, and fault deviations are shown in FIG. 4 for illustration purposes. In FIG. 4, a waveform profile 26 is modeled as a current differential |I₄₄ₐ−I_{44b}| as a function of time. The current differential is the difference between the electrical current traveling along one circuit pathway of the electronic device and the electrical current traveling along another circuit pathway of the electronic device, e.g., as in the configuration in FIG. 2. As indicated, the current difference is mostly 0 (zero), but there may be differences in current at regions P1 and P2 due to particular operational modes of the electronic device. The fault deviation 24 may take different forms depending on the particular configuration and nature of the electrical protection unit 14 and how it measures the operational power waveform 22. In one example, as indicated at 24a, the fault deviation is a constant offset “Δ” of the waveform profile 26. Here, for any particular point in time t1, if the measured power waveform 22 is at or below the waveform profile 26, the electrical protection unit 14 continues to monitor the power waveform 22. If the measured power waveform 22 is within A of the waveform profile 26 at time t1 (i.e., if the power waveform is at or below the fault deviation 24a at time t1), the electrical protection unit 14 continues to monitor the power waveform 22. If, however, the measured power waveform 22 is greater than A of the waveform profile 26 at time t1 (i.e., if the power waveform is above fault deviation 24a of the waveform profile at time t1), then a fault condition is considered to have occurred and the electrical protection unit 14 cuts off power to the electronic device. As should be appreciated, although the fault deviation 24a is constant with respect to the waveform profile 26, the overall effect is that the electrical conditions 48a by which a fault is deemed to have occurred vary over time.

As another example, as indicated at 24b, the fault deviation may vary with respect to the waveform profile 26. Correspondingly, the electrical conditions 48b by which a fault is deemed to have occurred in this example do not vary over time. Thus, at any point in time, if the power waveform 22 exceeds the current difference level of 48b (e.g., in effect, if the power waveform is above/outside the fault deviation 24b of the waveform profile 26), a fault condition is deemed to have occurred and the electrical protection unit 14 cuts off power to the electronic device.

As another example, as indicated at 24c, the fault deviation may incorporate considerations of time duration, that is, not only does the power waveform 22 have to deviate from the waveform profile by a designated amount/value for a fault condition, but by at least that amount/value for at least a designated duration. In the example shown in FIG. 4, the fault deviation has a value/amount that corresponds to deviation 24b, and a time period “T.” Thus, for a fault condition under 24c, the power waveform 22 must exceed the fault deviation 24b of the waveform profile 26 for at least time period T. Correspondingly, conditions or parameters 48c for determination of a device fault, for the electrical protection unit 14 to cut off power to the device, is that the power waveform 22 has to exceed the current difference level 48b for at least time period T. In other words, if the operational current difference, measured as the power waveform 22, exceeds the designated level 48b for at least time period T, the electrical protection unit 14 prevents electrical power from passing to the electronic device 12.

As noted above, it is not necessary for the electrical protection unit 14 to actually compare the power waveform 22, waveform profile 26, and/or fault deviation 24 per se (although doing so is one possibility). Instead, the electrical protection unit may be configured to prevent electrical power from passing to the electronic device if the power waveform 22 meets one or more designated fault conditions (e.g., exceeding a differential current level for a designated time period), where the designated fault conditions are selected so as to not be met by the electronic device when normally operating in any of its modes of operation. For example, with reference again to the fault conditions 48c in FIG. 4, the fault conditions 48c (namely, exceeding a differential current level 48b for a designated time period T) would be selected so that the electronic device 12 would not exceed the current level 48b for the designated time period T in any of its normal operational modes (which are reflected in the waveform profile 26).

In one embodiment, with reference to FIG. 5, the electrical protection unit 14 includes a power switch unit 50, a controller 52, and an electrical measurement and control interface unit 54. The switch unit 50 is connected in series between the external household source 16 and one of the power input terminals of the electronic device 12, e.g., the positive supply terminal of the electronic device's power supply. (As should be appreciated, although shown separate from the electronic device 12 in FIG. 4, the electrical protection unit 14 would typically be built in to the electronic device or at least housed in a common housing 28.) The switch unit 50 has one or more control inputs 56, and is controllable between an “open”/off state and a “closed”/on state. In the closed state, the electrical current is free to flow through the switch unit. In the open state, electrical current is substantially prevented from flowing through the switch unit, meaning a current level of no more than “X,” where X is the maximum allowed leakage current level for the type of electronic device in question, as set by the applicable standards body for the region in which the electronic device is to be used. (Typically, X<0.5 mA.) The switch unit 50 may be a FET-based circuit or other power transistor-based circuit, an electric relay or other solenoid based switch, or the like. The controller 52 operates according to a set of controller instructions (e.g., computer software, microinstructions, or the like), and is configured to monitor the power waveform 22 of the electronic device 12, that is, the controller monitors the electrical characteristics of one or more designated points of the electronic device. Using standard signal processing techniques, the controller 52 compares the power waveform 22 to the waveform profile 26 for the electronic device, which is stored as data in controller memory or otherwise, and determines if the power waveform 22 is outside the fault deviation 24 of the waveform profile. If so, the controller 52 controls the switch unit 50 for actuating the switch unit 50 from its closed state (allowing electrical power to pass) to its open state (substantially preventing electrical power from passing). The electrical measurement and control interface unit 54 includes whatever circuitry is required for interfacing the controller 52 with the switch unit 50 (for control of the switch unit) and the electronic device 12 (for measuring the power waveform), which will depend on the type of controller, the type of switch unit, and the particular configuration of the electronic device.

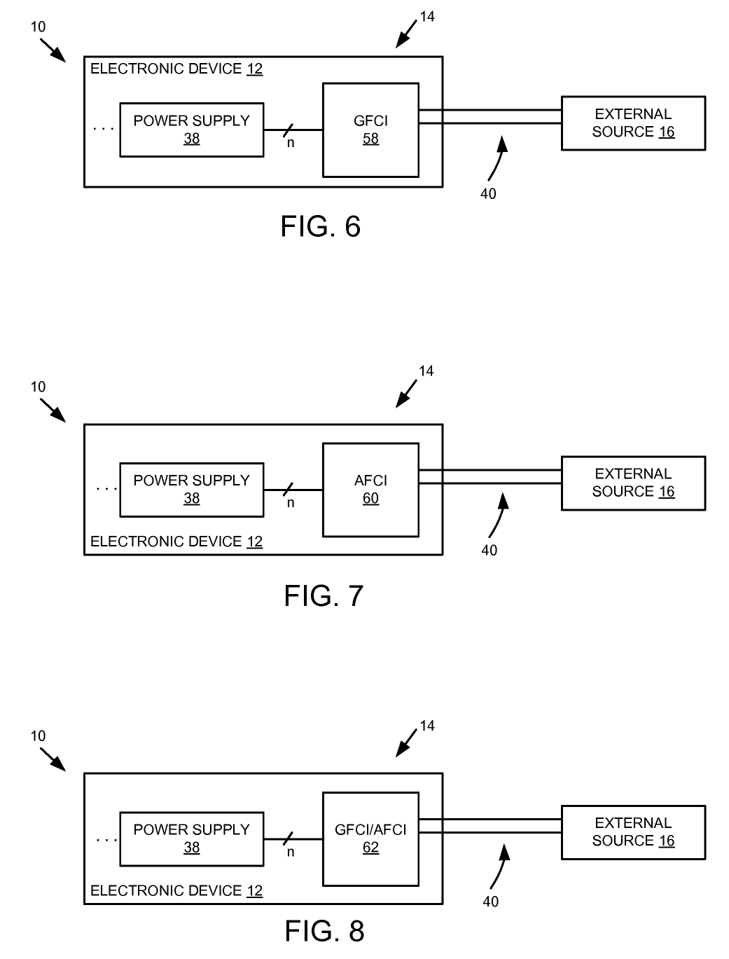

In another embodiment, as shown in FIG. 6, the electrical protection unit 14 is a GFCI (ground fault circuit interrupter) unit 58. The GFCI unit 58 is located inside the electronic device housing 28, and is electrically connected, for example, between the device's power supply 38 and the positive supply and ground/neutral lines of the electric cable 40. The GFCI unit 58 includes an internal current transformer and related circuitry, which continually monitor the electrical currents flowing through the positive supply and ground/neutral lines, for detecting a current imbalance there between (which is indicative of a current leak). The measured currents constitute the power waveform 22 of the electronic device 12. The fault condition(s) of the GFCI unit 58 is a current imbalance between the two lines that exceeds a designated level, in which case a relay or other switch unit internal to the GFCI unit 58 is actuated to an open state for preventing electrical power from passing to the power supply 38. The GFCI unit 58 is electrically configured so that its fault condition (e.g., a measured current imbalance exceeding a designated limit) is not met by the electronic device 12 in any of the electronic device's normal operational modes. For example, if the electronic device 12 exhibits a maximum current imbalance of “Y” mA in a startup mode, then the GFCI unit 58 is configured so that its fault level of current imbalance is “X” mA, where X>Y. (Time durations may also be taken into consideration.) In this example, Y is in effect part of the electronic device's waveform profile, and the difference between X and Y is the implied fault deviation.

In another embodiment, with reference to FIG. 7, the electrical protection unit 14 is an AFCI (arc fault circuit interrupter) unit 60, which serves to reduce instances of electrical fires due to internal electrical arcing. If the total current drawn by the electronic device is above a designated level for a designated time period (indicative of a non-intended electrical arc), a fuse-like element internal to the AFCI unit blows, creating an open circuit condition. The AFCI unit is configured so that the designated current/time level (i.e., the fault condition at which the internal fuse of the AFCI unit blows) is above the maximum current draw of the electronic device in any of its normal modes of operation.

In another embodiment, with reference to FIG. 8, the electrical protection unit 14 is a combination AFCI/GFCI unit 62. The combination AFCI/GFCI unit 62 may comprise separate AFCI and GFCI units, or a unit that includes both an AFCI-like fuse (and related circuitry) and a GFCI-like current transformer (and related circuitry).

The electrical protection unit 14 can be configured to control electrical power to the electronic device generally (e.g., to the totality of the electrical circuitry in the electronic device), or to one or more sub-portions or subsystems of the electronic device, e.g., to a high power AC subsystem but not a low power DC subsystem. Additionally, where it is described herein that the electrical protection unit 14 prevents power from passing from the external source to the electronic device, this includes any configuration where the electrical protection unit 14 creates a substantially open circuit condition in the electronic control device.

FIG. 9 summarizes an embodiment of the present invention that relates to a method for electrically protecting a household electronic device. At Step 100, an electrical waveform profile 26 of a household electronic device 12 is generated when the household electronic device is operating under designated normal conditions. An electrical protection unit 14 is selected at Step 102 based on the waveform profile 26. The electrical protection unit 14 is selected to allow electrical power to pass to the household electronic device 12 from an external household source 16 if an operational electric power waveform 22 of the household electronic device is within the waveform profile 26. Additionally, the electrical protection unit is selected to prevent electrical power from passing to the household electronic device from the external household source if the operational electric power waveform of the household electronic device falls outside a fault deviation 24 of the waveform profile 26. Once the electrical protection unit is selected, it is permanently integrated with the household electronic device at Step 104, prior to distribution of the household electronic device to a household end user. This prevents the electrical protection unit from being removed from the household electronic device without disabling the electronic device. Of course, the process of FIG. 9 can be carried out categorically, e.g., an electrical protection unit is selected based on the waveform profile of a prototype device, and then each production-level device is outfitted with a similar electrical protection unit.

Except where otherwise noted, the electrical devices, circuits, etc. described herein can be implemented using standard electrical components and design methods by one of ordinary skill in the art having the benefit of the present disclosure.

When it is characterized herein that electrical current, power, etc. is substantially prevented from passing to the electronic device or otherwise, this includes both (i) complete prevention (no current, power, etc. passing) or (ii) partial prevention where the amount of current, power, etc. allowed to pass is limited to levels that are classified as safe by the applicable standards body for the region in which the electronic device is to be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

What is claimed is:

1. An electrical protection system comprising:
a household electronic device comprising an electrical power unit and an electric work unit interfaced with the electrical power unit, wherein the electrical power unit is configured for detachable electric connection to a household source external to the electronic device and to utilize external electrical power received from the household source, said external electrical power having a first, standard power waveform, and wherein the electric work unit is configured to utilize internal electrical power received from the electrical power unit for carrying out one or more designated work functions of the electronic device, wherein the electronic device operates according to a second power waveform; and
an electrical protection unit permanently interfaced with the electronic device, wherein the electrical protection unit is configured to allow electrical power to pass from the household source to the electronic device if the second power waveform is within a waveform profile, and to substantially prevent electrical power from passing from the household source to the electronic device if the second power waveform is outside a fault deviation of the waveform profile, said waveform profile being indicative of normal electrical operation of the electronic device.

2. The system of claim 1 wherein the electrical protection unit comprises an AFCI unit.

3. The system of claim 1 wherein the electrical protection unit comprises a GFCI unit.

4. The system of claim 1 wherein the electrical protection unit comprises a combination GFCI/AFCI unit.

5. The system of claim 1 wherein the household electronic device is an electric appliance, the household source is a wall outlet, and the first power waveform is about 110-240 volts AC at 50-60 Hz.

6. The system of claim 5 wherein the electrical protection unit comprises one of an AFCI unit, a GFCI unit, or a combination GFCI/AFCI unit.

7. The system of claim 5 wherein:
the electrical power unit includes a power supply electrically connected to the electric work unit, an electric power cable electrically connected to the power supply, and a plug electrically terminating the electric power cable and configured for removable insertion into the wall outlet; and
the power supply is configured to convert the external electrical power at the first, standard power waveform to the internal electrical power at a third power waveform different from the first, standard power waveform.

8. The system of claim 7 wherein the electrical protection unit comprises one of an AFCI unit, a GFCI unit, or a combination GFCI/AFCI unit.

9. An electrical protection system for a household electric appliance, the system comprising:
an electric system at least partially housed in a housing of the electric appliance, said electric system including an electrical power unit and an electric work unit, wherein the electrical power unit is configured for detachable connection to an external household source for receiving external electrical power from the external household source, said electrical power unit being further configured to convert the external electrical power to internal electrical power for receipt and use by the electric work unit, and said external electrical power having a first power waveform of about 110-240 volts AC at 50-60 Hz, and wherein the electric work unit is configured to utilize the internal electrical power received from the electrical power unit for carrying out one or more designated work functions of the appliance, and wherein the electric system operates according to a second power waveform; and
an electrical protection unit permanently interfaced with the electric system, wherein the electrical protection unit is configured to allow the external electrical power to pass to the electric system from the household source if the second power waveform is within a waveform profile, and to substantially prevent the external electrical power from passing to the electric system from the household source if the second power waveform is outside a fault deviation of the waveform profile, said waveform profile being indicative of normal electrical operation of the household electric appliance;
wherein the electrical protection unit comprises one of an AFCI unit, a GFCI unit, or a combination GFCI/AFCI unit; and
wherein the electric system and electrical protection unit together comprise a totality of the electrical circuitry in the household electric appliance.

10. An electrical protection system comprising:
a household electronic device configured for detachable electric connection to an external household source and to utilize electrical power received from the household source, wherein the electronic device operates according to an electrical power waveform; and
an electrical protection unit permanently interfaced with the household electronic device, wherein the electrical protection unit is configured to allow electrical power to pass from the household source to at least part of the electronic device if the power waveform is within a waveform profile, and to substantially prevent electrical power from passing from the household source to said at least part of the electronic device if the power waveform is outside a fault deviation of the waveform profile, said waveform profile being indicative of normal electrical operation of the electronic device.

11. The system of claim 10 wherein the electrical protection unit comprises an AFCI unit.

12. The system of claim 10 wherein the electrical protection unit comprises a GFCI unit.

13. The system of claim 10 wherein the electrical protection unit comprises a combination GFCI/AFCI unit.

14. The system of claim 10 wherein the household electronic device is an electric appliance, the household source is a wall outlet, and the electronic device is configured to utilize electrical power at about 110-240 volts AC at 50-60 Hz as received from the household source.

15. The system of claim 14 wherein the electrical protection unit comprises one of an AFCI unit, a GFCI unit, or a combination GFCI/AFCI unit.

16. The system of claim 10 wherein the electrical protection unit is disposed in a primary electrical power supply path of the electronic device, and is configured to allow electrical power to pass from the household source to the electronic device generally if the power waveform is within the fault deviation of the waveform profile, and to prevent electrical power from substantially passing from the household source to the electronic device generally if the power waveform is outside the fault deviation of the waveform profile.

17. An electrical protection system comprising:
a household electronic device configured for detachable electric connection to an external household source and to utilize electrical power received from the household source; and
an electrical protection unit permanently interfaced with the household electronic device, wherein the electrical protection unit is configured to allow electrical power to pass to at least part of the household electronic device, from the external household source, if the electrical power drawn by the household electronic device is within a waveform profile indicative of normal electrical operation of the electronic device, and to substantially prevent electrical power from passing to said at least part of the household electronic device from the external household source if the electrical power drawn by the household electronic device is outside the waveform profile and meets one or more designated fault conditions.

18. The system of claim 17 wherein the electrical protection unit comprises one of an AFCI unit, a GFCI unit, or a combination GFCI/AFCI unit.

19. A method for electrically protecting a household electronic device, the method comprising:
generating an electrical waveform profile of the household electronic device during operation of the household electronic device under designated normal conditions;
selecting an electrical protection unit based on said waveform profile, wherein the electrical protection unit is selected to allow electrical power to pass to the household electronic device from an external household source if an operational electric power waveform of the household electronic device falls within the waveform profile, and wherein the electrical protection unit is selected to substantially prevent electrical power from passing to the household electronic device from the external household source if the operational electric power waveform of the household electronic device falls outside a fault deviation of the waveform profile; and
permanently integrating the electrical protection unit with the household electronic device, prior to distribution of the household electronic device to a household end user, so that the electrical protection unit cannot be removed from household electronic device by the household end user without disabling the electronic device.

20. The method of claim 19 wherein the electrical protection unit is selected for including one of an AFCI unit, a GFCI unit, or a combination GFCI/AFCI unit.
